(19) United States
(12) Patent Application Publication
(10) Pub. No.: US 2026/0135868 A1
(43) Pub. Date: May 14, 2026

(54) SYSTEMS AND METHODS FOR ADJUSTING SENSITIVITY OF A CHANGEPOINT DETECTION USING DYNAMIC HYPERPARAMETERS

(71) Applicant: Capital One Services, LLC, McLean, VA (US)

(72) Inventor: Zhengqing LIU, McLean, VA (US)

(73) Assignee: Capital One Services, LLC, McLean, VA (US)

(21) Appl. No.: 18/946,786

(22) Filed: Nov. 13, 2024

(51) Int. Cl. H04L 9/40

(52) U.S. Cl. CPC H04L 63/1425; H04L 63/1416

(57) ABSTRACT

The system may receive a first data stream comprising data points corresponding to a first period of time. The system may determine a first baseline condition for the first data stream using a first model, wherein the first model comprises a first number of changepoints. The system may receive a first dynamic hyperparameter, wherein the first dynamic hyperparameter comprises a first function that uses a first characteristic of the first model to generate a first output. The system may determine, based on the first output, a second number of changepoints for modeling the first data stream in a second model. The system may generate for display, in a user interface, a second baseline condition for the first data stream using the second model.

### BACKGROUND

Network monitoring is a systematic approach to overseeing the operation of a computer network. This process involves continuously observing and analyzing network traffic, performance, and availability to ensure optimal functionality and security. Utilizing specialized software tools, network administrators can track various metrics such as bandwidth usage, latency, uptime, and error rates. The primary goal of network monitoring is to detect and diagnose network issues promptly, preventing potential disruptions and minimizing downtime. Effective network monitoring also aids in capacity planning, security management, and ensuring compliance with organizational policies. By providing real-time insights and historical data, network monitoring helps maintain a robust and efficient network infrastructure, supporting the seamless operation of business processes and services.

In many instances, network monitoring requires determining a baseline condition from which potential outliers may be detected. Outlier events in network monitoring are unusual or unexpected occurrences that can indicate potential issues or threats within the network. Examples of such events include sudden spikes in network traffic, which could suggest a Distributed Denial of Service (DDoS) attack, or unexpected drops in traffic that might point to network outages or connectivity problems. Unusually high latency or packet loss can signal underlying network congestion or hardware failures, whereas unusual transaction activity may indicate potential fraud. Additionally, an increase in unauthorized access attempts or unusual patterns of data access can indicate security breaches or malicious activity. Other concerning outliers include significant changes in bandwidth consumption, unexpected device behavior, or anomalies in system performance metrics. Detecting these outlier events promptly is crucial for network administrators to investigate and mitigate potential problems, ensuring the network's reliability, performance, and security.

For example, when the system detects deviations from this established baseline, it can flag potential issues or outliers for further investigation (e.g., as an instance of a potential cyber-attack, fraud occurrence, system crash, etc.). This ability to set and adjust baselines dynamically allows systems to maintain optimal performance, enhance security, and promptly respond to unusual events. However, determining an outlier event requires determining the baseline condition, which may be difficult as the network conditions may change overtime. Detecting outlier events are thus dependent on correctly determining, and updating, a baseline condition for a network.

### SUMMARY

Systems and methods are described herein for novel uses and/or improvements to Artificial Intelligence and/or modeling applications, particularly in the realm of determining a baseline condition for a network. Artificial Intelligence, including, but not limited to, machine learning, deep learning, etc. and other modeling applications (referred to collectively herein as Artificial Intelligence models, machine learning models, or simply models) may aid in determining a baseline condition due to their ability to detect patterns and identify trends. For example, the system may determine a baseline condition by continuously collecting and analyzing data to detect patterns and identify trends over time. Initially, the system gathers extensive historical data, which serves as a reference point. Using statistical analysis and/or modeling algorithms, the system may identify normal operating ranges and behaviors for various metrics, such as network traffic, system performance, and/or user activity. By examining these data points, the system may establish what constitutes typical conditions under normal circumstances.

As more data is collected, the system refines the baseline to become more accurate and representative of the system's usual condition. While there are numerous ways to refine the baseline, the systems and methods described herein do so by detecting one or more changepoints. A changepoint in data modeling refers to a point within a dataset where the statistical properties of the data change significantly. This could mean a shift in the mean, variance, or other key characteristics of the data series. Identifying changepoints is crucial in time series analysis, as it helps to pinpoint moments when the behavior of the data undergoes a fundamental change. For instance, in financial markets, a changepoint might indicate a sudden shift in stock prices due to economic events. In network monitoring, it could signal a sudden change in traffic patterns, potentially due to an attack or a system upgrade.

Unfortunately, the use of changepoints to determine and/or update baseline conditions over time raises a novel technical problem. For example, when using changepoints, the system may retrieve a time series and divide the entire series into segments accordingly. Each segment may be fitted with a model (e.g., a linear model) that best explains the data (minimizes the unexplained variations). The more changepoints that are detected by the system, the more individual models are fitted, which leads to fewer unexplained variations. However, detecting too many changepoints leads to overfitting, which is counterproductive in most scenarios. Hence there is a tradeoff between how many changepoints are detected (e.g., the complexity of the model) and model fit (e.g., how well the data is explained).

To further exacerbate this technical problem, there is no “correct” number of changepoints for a given set of data because the number of changepoints often depends on the values set for one or more of the model's parameters. Similarly, given the complexity of most systems, there is no linear correlation between the value (or change therein) of the one or more parameters and the number of changepoints. Furthermore, it would be technically impractical (if not impossible) to determine these values and changes thereto, particular in instances of real-time data.

The systems and methods herein mitigate this technical problem through the use of a dynamic hyperparameter. In data modeling, a hyperparameter may be a configuration that is set before the learning process begins and controls the behavior of the training algorithm. Hyperparameters are not learned from the data; instead, they are specified by the practitioner and influence the model modeling/training process. In contrast, a parameter is a variable that the model learns from the data during the modeling/training process. Moreover, beyond even conventional hyperparameters, the system uses a dynamic hyperparameter whereby the hyperparameter itself changes based on one or more characteristics of a previously modeled baseline condition. That is, as opposed to a set value (e.g., a set number of changepoints), the dynamic hyperparameter may configure itself in real-time based on a previously determined baseline condition. By doing so, the impractical (if not impossible) task of determining values and/or changes to one or more parameters to arrive at a particular number of changepoints is avoided, while the system may still use changepoints with varying levels of sensitivity to determine and/or update baseline conditions over time.

In some aspects, systems and methods for adjusting sensitivity of changepoint detection using dynamic hyperparameters are described. For example, the system may receive a first data stream comprising data points corresponding to a first period of time. The system may determine a first baseline condition for the first data stream using a first model, wherein the first model comprises a first number of changepoints. The system may receive a first dynamic hyperparameter, wherein the first dynamic hyperparameter comprises a first function that uses a first characteristic of the first model to generate a first output. The system may determine, based on the first output, a second number of changepoints for modeling the first data stream in a second model. The system may generate for display, in a user interface, a second baseline condition for the first data stream using the second model.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a user interface used for changepoint detection, in accordance with one or more embodiments.

FIG. 2 shows an illustrative diagram for adjusting sensitivity of changepoint detection using various dynamic hyperparameters, in accordance with one or more embodiments.

FIG. 3 shows illustrative components for a system used for changepoint detection, in accordance with one or more embodiments.

FIG. 4 shows a flowchart of the steps involved in adjusting sensitivity of changepoint detection using dynamic hyperparameters, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

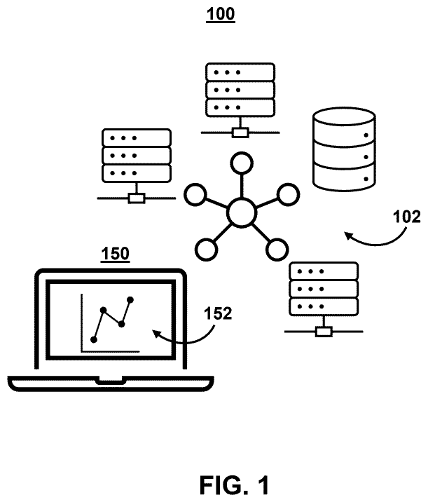

FIG. 1 shows an illustrative diagram for a user interface used for changepoint detection, in accordance with one or more embodiments. For example, system 100 may indicate a system for detecting network traffic disruptions based on varying network traffic baselines that are detected by adjusting a sensitivity of changepoint detection using dynamic hyperparameters. For example, network 102 may comprise a network that may receive traffic from various components. One such component is user device 150. User device 150 may include a user interface that may comprise content related to changepoint detection.

For example, network 102 may receive a first data stream comprising data points corresponding to network traffic over a first period of time by leveraging various network monitoring tools and protocols designed to capture and transmit traffic data. Initially, network monitoring devices such as routers, switches, or dedicated network probes are configured to observe and record traffic flow within the network. These devices collect data points that include information such as packet size, source and destination IP addresses, timestamps, and protocol types. The collected data is then formatted into a continuous data stream.

This data stream is transmitted to a central monitoring system or server using standardized network protocols like NetFlow, sFlow, or IPFIX, which are specifically designed for traffic analysis. The monitoring system, equipped with the necessary software and hardware, receives the data stream in real-time or at regular intervals, ensuring that all relevant traffic data points corresponding to the first period of time are captured accurately.

The central monitoring system processes the incoming data stream, storing the data points in a database or a temporary buffer for further analysis. This process may include filtering, aggregating, or pre-processing the data to ensure it is ready for subsequent steps such as anomaly detection, performance analysis, or security monitoring. By efficiently managing the data collection and transmission processes, the network ensures that it has a comprehensive and accurate record of traffic data points over the specified time period.

As shown in FIG. 1, user device 150 may present content 152. For example, the system may generate for display, in a user interface, an alert for a network traffic disruption based on detecting an outlier data point based on the second baseline traffic level. As referred to herein, a “user interface” may comprise a human-computer interaction and communication in a device, and may include display screens, keyboards, a mouse, and the appearance of a desktop. For example, a user interface may comprise a way a user interacts with an application or a website.

As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user generated content may include content created and/or consumed by a user. For example, user generated content may include content created by another, but consumed and/or published by the user.

In some embodiments, the content and/or data may comprise time-series data. As described herein, “time-series data” may include a sequence of data points that occur in successive order over some period of time. In some embodiments, time-series data may be contrasted with cross-sectional data, which captures a point-in-time. A time series can be taken on any variable that changes over time. The system may use a time series to track the variable (e.g., price) of an asset (e.g., security) over time. This can be tracked over the short term, such as the price of a security on the hour over the course of a business day, or the long term, such as the price of a security at close on the last day of every month over the course of five years. The system may generate a time series analysis. For example, a time series analysis may be useful to see how a given asset, security, or economic variable changes over time. It can also be used to examine how the changes associated with the chosen data point compare to shifts in other variables over the same time period. For example, with regards to retail loss, the system may receive time series data for the various sub-segments indicating daily values for theft, product returns, etc.

The time-series analysis may determine various trends such as a secular trend, which describe the movement along the term, a seasonal variation, which represent seasonal changes, cyclical fluctuations, which correspond to periodical but not seasonal variations, and irregular variations, which are other nonrandom sources of variations of series. The system may maintain correlations for this data during modeling. In particular, the system may maintain correlations through non-normalization as normalizing data inherently changes the underlying data which may render correlations, if any, undetectable and/or lead to the detect of false positive correlations. For example, modeling techniques (and the predictions generated by them), such as rarefying (e.g., resampling as if each sample has the same total counts), total sum scaling (e.g., dividing counts by the sequencing depth), and others, and the performance of some strongly parametric approaches, depends heavily on the normalization choices. Thus, normalization may lead to lower model performance and more model errors. The use of anon-parametric bias test alleviates the need for normalization, while still allowing the methods and systems to determine a respective proportion of error detections for each of the plurality of time-series data component models. Through this unconventional arrangement and architecture, the limitations of the conventional systems are overcome. For example, non-parametric bias test are robust to irregular distributions, while providing an allowance for covariate adjustment. Since no distributional assumptions are made, these tests may be applied to data that has been processed under any normalization strategy or not processed under a normalization process at all.

As referred to herein, “a data stream” may refer to data that is received from a data source that is indexed or archived by time. This may include streaming data (e.g., as found in streaming media files) or may refer to data that is received from one or more sources over time (e.g., either continuously or in a sporadic nature). A data stream segment may refer to a state or instance of the data stream. For example, a state or instance may refer to a current set of data corresponding to a given time increment or index value. For example, the system may receive time series data as a data stream. A given increment (or instance) of the time series data may correspond to a data stream segment.

For example, in some embodiments, the analysis of time-series data presents comparison challenges that are exacerbated by normalization. For example, a comparison of original data from the same period in each year does not completely remove all seasonal effects. Certain holidays such as Easter and Chinese New Year fall in different periods in each year, hence they will distort observations. Also, year-to-year values will be biased by any changes in seasonal patterns that occur over time. For example, consider a comparison between two consecutive March months (i.e., compare the level of the original series observed in March for 2000 and 2001). This comparison ignores the moving holiday effect of Easter. Easter occurs in April for most years but if Easter falls in March, the level of activity can vary greatly for that month for some series. This distorts the original estimates. A comparison of these two months will not reflect the underlying pattern of the data. The comparison also ignores trading day effects. If the two consecutive months of March have different composition of trading days, it might reflect different levels of activity in original terms even though the underlying level of activity is unchanged. In a similar way, any changes to seasonal patterns might also be ignored. The original estimates also contain the influence of the irregular component. If the magnitude of the irregular component of a series is strong compared with the magnitude of the trend component, the underlying direction of the series can be distorted. While data may in some cases be normalized to account for this issue, the normalization of one data stream segment (e.g., for one component model) may affect another data stream segment (e.g., for another component model). Individual normalizations may distort the relationship and correlations between the data leading to issues and negative performance of a composite data model.

As referred to herein, a “modeling error” or simply an “error” may correspond to an error in the performance of the model. For example, an error in a model may comprise an inaccurate or imprecise output or prediction for the model. This inaccuracy or imprecision may manifest as a false positive or a lack of detection of a certain event. These errors may occur in models corresponding to a particular sub-segment (e.g., a component model as described herein) that result in inaccuracies for predictions and/or output based on the sub-segment, and/or the errors may occur in models corresponding to an aggregation of multiple sub-segments (e.g., a composite model as described herein) that result in inaccuracies for predictions and/or outputs based on errors received in one or more of predictions of the plurality of sub-segments and/or an interpretation of the predictions of the plurality of sub-segments.

The system may monitor content generated by the user to generate user profile data. As referred to herein, “a user profile” and/or “user profile data” may comprise data actively and/or passively collected about a user. For example, the user profile data may comprise content generated by the user and a user characteristic for the user. A user profile may be content consumed and/or created by a user.

User profile data may also include a user characteristic. As referred to herein, “a user characteristic” may include about a user and/or information included in a directory of stored user settings, preferences, and information for the user. For example, a user profile may have the settings for the user's installed programs and operating system. In some embodiments, the user profile may be a visual display of personal data associated with a specific user, or a customized desktop environment. In some embodiments, the user profile may be digital representation of a person's identity. The data in the user profile may be generated based on the system actively or passively monitoring.

To generate content 152 (e.g., an alert about an outlier to a baseline) the system may use changepoints to determine and/or update baseline conditions over time. For example, when using changepoints, the system may retrieve a time series and divide the entire series into segments accordingly. Each segment may be fitted with a model (e.g., a linear model) that best explains the data (minimizes the unexplained variations). The more changepoints that are detected by the system, the more individual models are fitted, which leads to fewer unexplained variations.

For example, the system may divide the first data stream into a series of segments, wherein the segments of the series of segments are separated by changepoints. The system may collect and preprocess the data stream, ensuring that it is clean and formatted appropriately for analysis. The system may then apply statistical, or machine learning algorithms designed to detect changepoints, which are points in the data where there are significant shifts in statistical properties such as mean, variance, or distribution. The system may scan the data stream, continuously analyzing it to identify these changepoints. Techniques such as Bayesian changepoint detection, kernel-based methods, or dynamic programming can be employed to accurately pinpoint these shifts. Once a changepoint is detected, the system marks the end of one segment and the beginning of another.

For example, the system may determine respective baseline traffic levels for each of the segments. Each segment thus represents a continuous interval of data with relatively stable characteristics. This segmentation process is iterative, with the system repeatedly applying its changepoint detection algorithm across the entire data stream. As each changepoint is identified, the system updates its segmentation, creating a series of segments that reflect the underlying structure of the data. These segments can then be further analyzed to understand the behavior of the data within each interval, enabling more accurate modeling, forecasting, or anomaly detection. By dividing the data stream into segments based on changepoints, the system ensures that each segment represents a homogenous period, facilitating more precise and meaningful analysis. This method enhances the system's ability to adapt to changes in the data and provides a clearer understanding of the data's temporal dynamics.

For example, the system may aggregate the respective baseline traffic levels to determine a first baseline traffic level for the first data stream. For example, the system divides the data stream into segments based on identified changepoints, with each segment representing a period where traffic characteristics are relatively stable. For each segment, the system calculates baseline traffic levels, which might include average traffic volume, peak traffic times, and other relevant statistical measures. Once the baseline traffic levels for individual segments are established, the system aggregates these metrics to form a comprehensive baseline for the entire data stream. This aggregation process involves several steps. In some embodiments, the system normalizes the baseline metrics to ensure they are comparable across segments. It may then calculate a weighted average of the traffic levels, where weights are assigned based on the length of each segment or the segment's importance to overall traffic patterns. Additionally, the system can use statistical methods such as time-series analysis to combine the segment baselines, considering factors like seasonality and trends that span multiple segments. The aggregated baseline traffic level reflects the typical traffic behavior over the entire period of the data stream, accounting for variations captured in each segment. This combined baseline is then refined through iterative analysis, where the system checks for consistency and accuracy, adjusting the aggregated baseline if necessary. By aggregating the respective baseline traffic levels from each segment, the system provides a robust and comprehensive first baseline traffic level for the entire data stream, which can be used for monitoring, anomaly detection, and optimizing network performance.

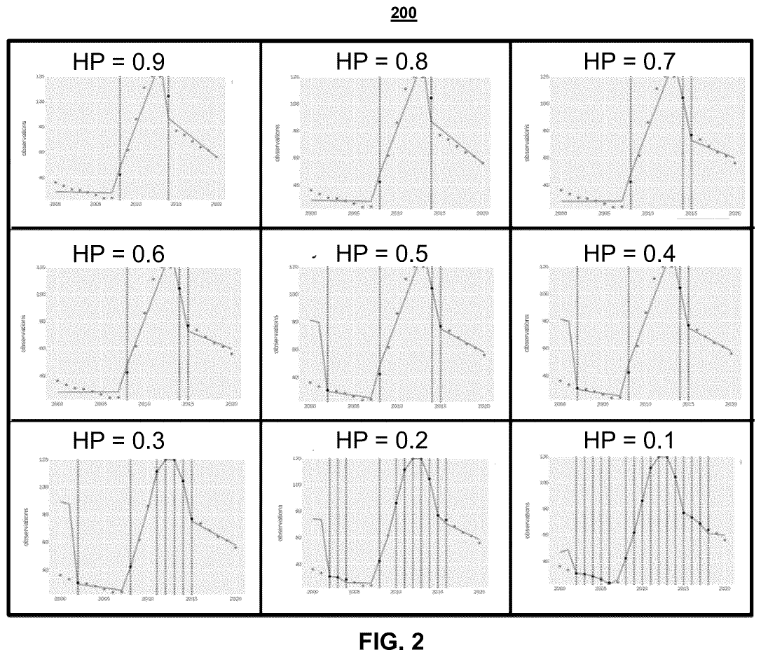

FIG. 2 shows an illustrative diagram for adjusting sensitivity of changepoint detection using various dynamic hyperparameters, in accordance with one or more embodiments. For example, the system may receive a first dynamic hyperparameter, wherein the first dynamic hyperparameter comprises a first function that uses a first characteristic of the first baseline traffic level to generate a first output. As shown in FIG. 2, a user may modify manually (or the system may determine automatically) various dynamic hyperparameters.

For example, the system may use a dynamic hyperparameter that comprises a function which, based on the characteristics of a first model, generates a first output, which is then used to determine the number of changepoints for a second model of the data stream. For example, the system may begin by analyzing metrics and attributes from the first model, such as the fit of the model to the data stream, the complexity of the model, and the number of changepoints initially identified.

The system may then employ a dynamic hyperparameter function that integrates these characteristics to evaluate the first model's performance for a user's objective. For example, the fit of the first model, measured by error rates or goodness-of-fit metrics, provides insight into how well the model captures the data's underlying structure. If the fit is poor, and the use wishes to increase the fit, the function might suggest increasing the number of changepoints to capture additional variations in the data.

Similarly, if the complexity of the first model, including the number of parameters and the model's capacity to generalize, is taken into account, a highly complex model with many parameters might indicate that fewer changepoints are needed, as the model can already capture intricate patterns. Conversely, a simpler model might benefit from more changepoints to improve its performance. The number of changepoints in the first model may directly influence the dynamic hyperparameter function. If the initial number of changepoints leads to overfitting or underfitting, the function adjusts this number accordingly. For instance, if overfitting is detected, the function may reduce the number of changepoints to simplify the model, while underfitting would prompt an increase to better capture the data's variability.

The dynamic hyperparameter function processes these inputs and generates an output that represents an optimal or improved number of changepoints for the second model. This output is used to reconfigure the second model, ensuring that it is better suited to the data stream's characteristics. By dynamically adjusting based on the first model's performance and attributes, the system can iteratively refine the model to enhance accuracy and generalization, ultimately leading to a more robust and reliable representation of the data stream. This approach allows the system to learn from the first model's outcomes and continuously improve the modeling process, ensuring that the second model is more effective in capturing significant changes and trends within the data.

Diagram 200 in FIG. 2 may represent the effect of different hyperparameters (or values thereof) on modeling a data stream. As shown in diagram 200, a different hyperparameter (or value thereof) may result in a different number of changepoints for modeling the first data stream. For example, the system may determine changepoints in a time series and divide the entire series into segments accordingly. Each segment may then be fitted with a linear model that best explains the data (e.g., minimizes the unexplained variation). The more changepoints are detected, the more linear models are to be fitted, and hence the unexplained variation smaller. However, this may lead to overfitting and detecting too many changepoints, which does not help most users. Hence, the system may address the tradeoff between how many changepoints are detected (e.g., the complexity of the model) and model fit (e.g., how well the data is explained). The system may give users the power to adjust the extent of this tradeoff. When more emphasis is placed on ‘improving fit’, users may get (or request) more changepoints. When more emphasis is placed on ‘limiting complexity’, users may get (or request) fewer changepoints. This is represented by a positive numeric value, called ‘penalty parameter’ or hyperparameter (e.g., “HP”) and its associated value in diagram 200. As shown in diagram 200, as the penalty parameter is reduced, the number of changepoints increase.

When determining a second number of changepoints for modeling the first data stream in a second model, a system may analyze the results and insights gained from the first model. For example, the system may analyze the initial changepoints, number of changepoints, and/or baseline conditions determined based on the changepoints and evaluates their impact on the model's performance, including how well these points capture significant shifts in the data's underlying structure. Based on this evaluation, the system may consider whether additional changepoints or different placements could better capture the nuances of the data.

To identify the second set of changepoints, the system may use the dynamic hyperparameter. For example, the dynamic hyperparameter may include a function that employs various techniques and algorithms designed for changepoint detection, such as Bayesian changepoint detection, the Pruned Exact Linear Time (PELT) method, or the Cumulative Sum (CUSUM) method. These algorithms analyze the data stream for statistical anomalies, looking for changes in the mean, variance, or other statistical properties that indicate a shift. The system might also incorporate more sophisticated machine learning methods, such as Hidden Markov Models (HMMs) or time series decomposition methods, to identify potential changepoints.

In some embodiments, the system may use cross-validation techniques to compare different models with varying numbers of changepoints, assessing their performance metrics such as prediction accuracy, error rates, and the ability to generalize to new data. By comparing these models, the system can determine whether adding more changepoints improves the fit and predictive power or if it leads to overfitting. Furthermore, domain knowledge and context-specific information can guide the selection of changepoints. For example, in financial data modeling, known economic events or policy changes might suggest additional relevant changepoints. The system may also use an iterative approach, refining the number and placement of changepoints based on feedback from the second model's performance and adjusting as necessary to achieve the best balance between model complexity and accuracy. Ultimately, the system combines statistical analysis, algorithmic detection, cross-validation, and domain-specific insights to determine a second number of changepoints, aiming to enhance the model's ability to capture significant changes in the data stream and improve overall predictive performance.

The system may then determine a second baseline traffic level for the first data stream based on the number of changepoints. For example, as shown in diagram 200, the baseline condition for the data stream is changed (as modeled) based on the difference in changepoints due to the dynamic hyperparameter. The baseline condition for a data stream may be significantly influenced by the number of changepoints, which are points where the statistical properties of the data change. When the dynamic hyperparameter is fine-tuned to be more sensitive, it tends to detect a higher number of changepoints, indicating frequent shifts in the baseline condition. Conversely, if the hyperparameter is less sensitive, fewer changepoints are detected, suggesting a more stable baseline. The detection of more changepoints can result in a model that is highly responsive to changes, capturing short-term fluctuations and possibly identifying anomalies or shifts in trends. However, this can also lead to increased complexity and potential overfitting. On the other hand, fewer changepoints might indicate a smoother, more generalized model that captures long-term trends but might miss smaller, more subtle changes. Therefore, the choice of the dynamic hyperparameter and the resulting number of changepoints is used in defining the stability and responsiveness of the baseline condition in a data stream model.

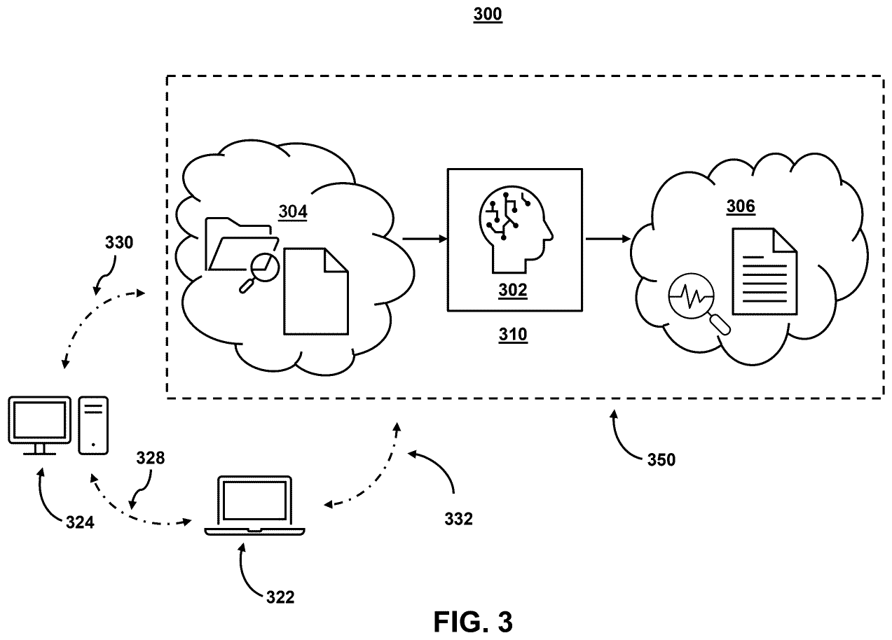

FIG. 3 shows illustrative components for a system used for changepoint detection, in accordance with one or more embodiments. For example, FIG. 3 may show illustrative components for detecting network traffic disruptions based on varying network traffic baselines that are detected by adjusting a sensitivity of changepoint detection using dynamic hyperparameters. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, Artificial Intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., a number of changepoints, a characteristic of data, model, etc., a baseline condition (for a segment or a data stream), and/or location of a changepoint).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., a number of changepoints, a characteristic of data, model, etc., a baseline condition (for a segment or a data stream), and/or location of a changepoint). In some embodiments, the model (e.g., model 302) may automatically perform actions based on outputs 306. In some embodiments, the model (e.g., model 302) may not perform any actions. The output of the model (e.g., model 302) may be used to determine a number of changepoints, a characteristic of data, model, etc., a baseline condition (for a segment or a data stream), and/or location of a changepoint.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDoS protection, and API layer 350 may use RESTful APIs as standard for external integration.

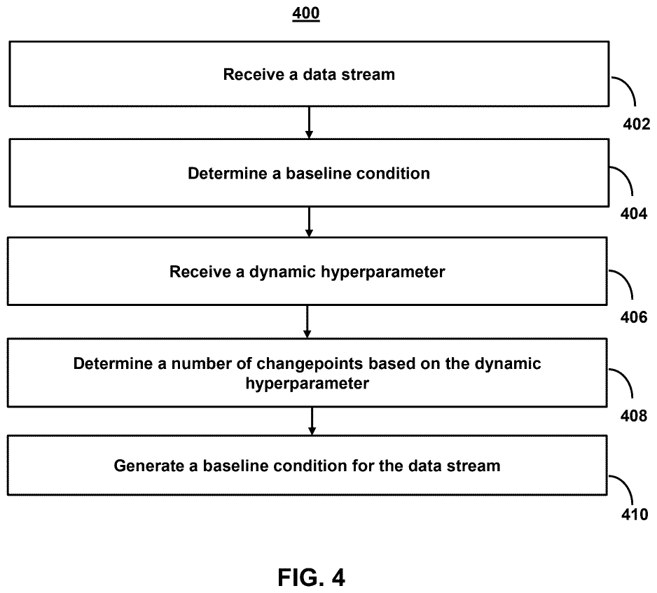

FIG. 4 shows a flowchart of the steps involved in adjusting sensitivity of changepoint detection using dynamic hyperparameters, in accordance with one or more embodiments. For example, the system may use process 400 (e.g., as implemented on one or more system components described above) in order to detect outliers based on varying baselines that are determined by adjusting a changepoint sensitivity using dynamic hyperparameters.

At step 402, process 400 (e.g., using one or more components described above) receives a data stream. For example, the system may receive a first data stream comprising data points corresponding to a first period of time. The system may receive a first data stream comprising data points corresponding to a first period of time by establishing a connection with a data source that continuously or intermittently transmits data. This process typically involves the system initiating a request or opening a communication channel with the data source, which could be a sensor, a database, an online API, or another data-generating entity. As the data stream begins, the system collects incoming data points, each associated with a specific timestamp, ensuring that these data points fall within the designated first period of time. The system might use protocols such as HTTP, WebSocket, or MQTT, among others, to facilitate this data transmission. It then processes, stores, or forwards the data points as required for further analysis or real-time decision-making. This operation requires synchronization mechanisms to accurately capture the time-specific data and manage any potential latency or data loss issues that might arise during transmission.

At step 404, process 400 (e.g., using one or more components described above) determines a baseline condition. For example, the system may determine a first baseline condition for the first data stream using a first model, wherein the first model comprises a first number of changepoints. The system may apply a model to the data stream, employing statistical techniques or machine learning algorithms to detect changepoints. By doing so, the system segments the data into intervals where the behavior is relatively consistent. The baseline condition is then established by examining these intervals to determine the normal or expected range of values for the data stream. This involves calculating key metrics such as average, standard deviation, and other relevant statistical parameters within each segment defined by the changepoints. The result is a comprehensive baseline condition that reflects the typical behavior of the data stream over the first period, accounting for any significant changes captured by the model's changepoints.

At step 406, process 400 (e.g., using one or more components described above) receives a dynamic hyperparameter. For example, the system may receive a first dynamic hyperparameter, wherein the first dynamic hyperparameter comprises a first function that uses a first characteristic of the first model to generate a first output. The system may be programmed or configured to accept hyperparameters that can change based on the model's characteristics or the data it processes. The first dynamic hyperparameter may be defined by a function that takes into account a specific characteristic of the model, such as its complexity, the number of changepoints, and/or other structural attributes. When the system initializes or updates the model, it calls this function, passing in the relevant characteristic as an input parameter. The function then processes this input to produce the first output, which might be a value used to fine-tune the model's performance or adapt its behavior in response to new data. This output can be used to optimize various aspects of the model, such as learning rates, thresholds, or regularization parameters, ensuring that the model remains robust and effective under different conditions. The system's ability to dynamically adjust hyperparameters based on model characteristics enhances its flexibility and responsiveness, allowing it to maintain optimal performance as the data environment evolves.

In some embodiments, the first function may determine a complexity of a model and recommend a number of changepoints based on that complexity. For example, the system may determine the complexity of a model by evaluating one or more characteristics that influence the model's capacity to learn and generalize from data. One characteristic is the number of parameters within the model, such as the weights and biases in a neural network or the coefficients in a regression model. Models with a larger number of parameters typically have greater complexity, as they can capture more intricate patterns but also risk overfitting. Another important factor is the model architecture, including the depth and breadth of layers in neural networks, the number of trees and their depth in random forests, and the polynomial degree in regression models. Additionally, the type of algorithms and functions used, such as non-linear activation functions or kernel methods, contribute to the model's complexity by allowing for more sophisticated data transformations. The system also considers the training data's size and dimensionality, as high-dimensional data can lead to more complex models to capture relationships accurately. Regularization techniques and hyperparameter settings, such as dropout rates or penalty terms, further influence complexity by controlling the model's flexibility and preventing overfitting.

For example, the first function may determine a number of parameters within the first model and determine the first characteristic based on the number of parameters. The system may system apply the first function to the model, which involves inspecting and evaluating the model's architecture to count the total number of parameters it contains. This function might traverse through the model's layers, summing up weights, biases, and other adjustable parameters to ascertain the complete parameter count. Once the number of parameters is determined, the system uses this information to establish the first characteristic, which is a key attribute derived from the parameter count. For instance, the first characteristic could be computational complexity, memory requirements, or a performance metric such as the model's capacity to generalize from training data. By basing the first characteristic on the number of parameters, the system can make informed decisions or adjustments, such as optimizing resource allocation, tuning hyperparameters, or scaling the model to better fit operational constraints.

Additionally or alternatively, the first function may determine a size of a layer within the first model and determine the first characteristic based on the size of the layer. The first function may examine the model's architecture to identify the specific layer of interest. It then calculates the size of this layer, which typically involves counting the number of neurons in a neural network layer or the number of units/filters in a convolutional layer. This calculation considers the layer's dimensions, such as input and output shapes, to accurately determine its size. Once the size of the layer is determined, the system uses this information to derive the first characteristic, which could be a performance-related attribute such as processing time, memory usage, or the layer's contribution to the model's overall accuracy. For instance, a larger layer might indicate higher computational demands and longer training times, while also potentially enhancing the model's capacity to learn complex patterns. By basing the first characteristic on the layer size, the system can make informed adjustments to optimize the model's architecture. This might involve tuning hyperparameters, balancing computational resources, or modifying the model to achieve better performance. This process ensures that the model is both efficient and effective, with the layer size guiding strategic decisions to enhance overall functionality.

Additionally or alternatively, the first function may determine a type of activation function used by the first model and determine the first characteristic based on the type of activation function. For example, the first function scans through the model to identify the activation functions applied within its layers. This involves inspecting the configuration of each layer to detect whether it uses activation functions such as ReLU (Rectified Linear Unit), Sigmoid, Tanh, or another variant. The first function categorizes each activation function based on its identified type. Once the type of activation function is determined, the system uses this information to establish the first characteristic. This characteristic is derived from the specific properties and impacts of the activation function type. For example, the ReLU activation function is known for its ability to mitigate the vanishing gradient problem, leading to faster training and improved performance in deep networks. In contrast, the Sigmoid function is often associated with binary classification tasks due to its output range of 0 to 1. By identifying the type of activation function, the system can infer critical characteristics such as computational efficiency, suitability for specific tasks, or impact on gradient flow. These insights enable the system to make informed decisions about model optimization. For instance, if the system detects that a model is using an activation function that may slow down training or lead to gradient issues, it can recommend adjustments or alternative activation functions. This process ensures that the model's design is aligned with its performance goals, leveraging the type of activation function to guide strategic improvements and achieve optimal functionality.

Additionally or alternatively, the first function may determine a size of a training data set used to train the first model and determine the first characteristic based on the size of the training data set. For example, the first function may evaluate the data set to count the number of samples or instances it contains. This involves reading the data set from its source, such as a database or file system, and performing a tally of the total entries. The function might also assess additional dimensions of the data, such as the number of features per sample, to gain a comprehensive understanding of the data set's size.

Once the size of the training data set is determined, the system uses this information to derive the first characteristic, which could be a measure of the model's expected performance, training duration, or resource requirements. For instance, a larger training data set typically implies that the model can achieve better generalization and accuracy, as it has more examples to learn from. However, it also means that more computational resources and time will be required to process the data during training. Conversely, a smaller data set may lead to faster training but could result in overfitting or poor generalization. By basing the first characteristic on the size of the training data set, the system can make informed adjustments to optimize the training process. This might involve selecting appropriate batch sizes, determining suitable learning rates, or deciding whether data augmentation techniques are needed to artificially expand the data set. This process ensures that the model's training is efficient and effective, with the data set size guiding strategic decisions to enhance overall model performance and resource utilization.

Additionally or alternatively, the first function may determine a penalty term for the first model and determine the first characteristic based on the penalty term. For example, the first function examines the model to identify the type and magnitude of regularization needed to prevent overfitting and enhance generalization. Common types of penalty terms include L1 (Lasso) and L2 (Ridge) regularization, which add a penalty proportional to the absolute value or the square of the coefficients, respectively. The function calculates the appropriate penalty term by assessing the model's complexity, such as the number of parameters, and the desired balance between fitting the training data and maintaining model simplicity.

Once the penalty term is determined, the system uses this information to establish the first characteristic, which is typically related to the model's performance metrics or stability. For example, a higher penalty term might reduce the model's variance, leading to more stable and consistent predictions but potentially increasing bias. Conversely, a lower penalty term might allow the model to fit the training data more closely, reducing bias but increasing the risk of overfitting and high variance on new data. By determining the first characteristic based on the penalty term, the system can make informed decisions to optimize the model. This might involve fine-tuning the regularization strength to achieve the best trade-off between bias and variance, ensuring that the model performs well on unseen data while avoiding overfitting. The penalty term guides these adjustments, helping to maintain an optimal balance that enhances the model's robustness and predictive accuracy.

Additionally or alternatively, the first function may determine a penalty term for the first model and determine the first characteristic based on the penalty term. For example, the first function determines a polynomial degree of the first model and determine the first characteristic based on the polynomial degree. The first function may examine the model's formulation to identify the highest power of the input variable used, which indicates the polynomial degree. For instance, in a polynomial regression model, the degree represents the highest exponent applied to the predictor variables. The function may involve fitting several candidate models with varying degrees and evaluating their performance using metrics such as R-squared, mean squared error, or cross-validation scores to select the optimal degree that best captures the underlying data patterns without overfitting.

Once the polynomial degree is determined, the system uses this information to establish the first characteristic, which typically relates to the model's flexibility, complexity, and predictive capability. A higher polynomial degree allows the model to fit more complex, nonlinear relationships within the data, potentially improving accuracy on the training set. However, it also increases the risk of overfitting, where the model captures noise instead of the actual underlying trend, leading to poor generalization on new data. Conversely, a lower polynomial degree might simplify the model, enhancing its ability to generalize but potentially underfitting the data if the true relationship is more complex. By determining the first characteristic based on the polynomial degree, the system can make informed decisions to balance model complexity and generalization. This process might involve selecting the polynomial degree that provides the best performance on validation data, ensuring that the model remains both accurate and robust when applied to unseen data. The polynomial degree thus guides strategic adjustments, helping to optimize the model's overall effectiveness and reliability.

In some embodiments, receiving the first dynamic hyperparameter may comprise the system receiving a first value from a user, determining, using the first function, a required characteristic based on the first value, comparing the required characteristic to the first characteristic, and generating the first output based on comparing the required characteristic to the first characteristic. The system receives a first dynamic hyperparameter from a user operates through an interactive and iterative process. The system may allow the user to input a first value, which serves as the dynamic hyperparameter. This value is then processed using a predefined first function to determine a required characteristic associated with the hyperparameter. For instance, if the hyperparameter pertains to a machine learning model, the first function might calculate necessary performance metrics or resource requirements based on the input value. Once the required characteristic is determined, the system compares it to a pre-existing first characteristic, which represents the baseline or current state. This comparison involves evaluating whether the required characteristic meets, exceeds, or falls short of the first characteristic. Based on this comparison, the system generates the first output, which could be a recommendation, an adjustment to the model, or a feedback message to the user. This output informs the user of the suitability of the input value and whether further modifications are needed to achieve desired outcomes. The dynamic nature of the hyperparameter ensures that the system remains adaptable and responsive to varying inputs and requirements.

In some embodiments, receiving the first dynamic hyperparameter comprises the system receiving a first value from a user, determining, using the first function, a type of a required characteristic based on the first value, and selecting the first characteristic from a plurality of characteristics based on the type. For example, using a predefined first function, the system analyzes this value to determine the type of a required characteristic. This function might involve computations or logical operations that classify the first value into a specific type category. For example, if the hyperparameter pertains to tuning a machine learning model, the function might identify whether the value corresponds to a parameter affecting model complexity, training duration, and/or accuracy. Once the type of required characteristic is determined, the system then selects the first characteristic from a plurality of characteristics available within its database or repository. This selection is based on the identified type, ensuring that the chosen characteristic aligns with the user's input value. The system's ability to dynamically determine and select the appropriate characteristic based on the type ensures that the hyperparameter tuning is precise and contextually relevant, facilitating optimal system performance and user satisfaction.

In some embodiments, the first function may determine a fit of a model and recommend a number of changepoints based on that fit. The system may determine the fit of a model to a data stream by assessing how well the model's predictions align with the actual data. This assessment may involve several characteristics and metrics. One characteristic may be the error rate, which can be measured using various techniques depending on the type of model and data. For regression models, common error metrics include Mean Squared Error (MSE), Root Mean Squared Error (RMSE), and Mean Absolute Error (MAE). For classification models, accuracy, precision, recall, and F1 score are typically used. These metrics provide quantitative measures of the discrepancies between predicted and actual values. Additionally, the system might use visual tools such as residual plots for regression models or confusion matrices for classification models to qualitatively assess model fit. Residual plots help in identifying patterns that the model may have missed, indicating underfitting or overfitting. Confusion matrices reveal how well the model distinguishes between different classes and where it makes errors.

Another characteristic may be the model's performance on validation or test datasets that were not used during the training phase. Using this data, the system may evaluate the model's generalization ability, ensuring it performs well on unseen data. Cross-validation techniques, such as k-fold cross-validation, may be used to provide a more robust estimate of model performance. For example, the system may also consider overfitting and underfitting indicators. Overfitting occurs when the model performs exceptionally well on training data but poorly on validation data, suggesting it has learned noise rather than the underlying patterns. Conversely, underfitting indicates the model is too simplistic to capture the data's complexity, performing poorly on both training and validation data. Regularization techniques, such as L1 or L2 regularization, and hyperparameter tuning also play a role in determining and improving model fit. These methods help in finding the right balance between model complexity and performance, preventing overfitting and enhancing generalization.

At step 408, process 400 (e.g., using one or more components described above) determines a number of changepoints based on the dynamic hyperparameter. For example, the system may determine, based on the first output, a second number of changepoints for modeling the first data stream in a second model. The system determines a second number of changepoints for modeling the first data stream based on a first output generated by a dynamic hyperparameter by using the output as a guiding parameter in the model adjustment process. For example, the system may receive the first output, which is the result of a function utilizing a specific characteristic of the first model. This output may reflect the current performance, stability, and/or complexity of the model, data, and/or objective. The system then analyzes this output to decide how to configure the model for improved accuracy or efficiency. In this context, the dynamic hyperparameter's output might indicate the need for more or fewer changepoints based on factors like data variability or detected patterns. For instance, if the first output suggests high data variability, the system might determine that additional changepoints are necessary to capture more granular shifts in the data trend. Conversely, if the output indicates stability, the system might opt for fewer changepoints to avoid overfitting and ensure the model remains generalizable. To implement this, the system integrates the first output into its modeling algorithm, which adjusts the number of changepoints accordingly. This involves recalculating the optimal points where changes in the statistical properties of the data stream occur. By dynamically adjusting the number of changepoints based on the first output, the system ensures that the model is more finely tuned to the characteristics of the data stream, leading to more accurate and reliable predictions or analyses. This process enhances the system's adaptability and effectiveness in various data scenarios.

At step 410, process 400 (e.g., using one or more components described above) generates a baseline condition for the data stream. For example, the system may generate for display, in a user interface, a second baseline condition for the first data stream using the second model. The system may generate for display, in a user interface, a second baseline condition for the first data stream using the second model by first applying the second model to the data stream to identify significant patterns and trends. The second model, now configured with a refined number of changepoints, processes the data to establish intervals of consistent behavior. Within these intervals, the system calculates key metrics such as average values, standard deviations, and other statistical parameters that define the second baseline condition.

Once the second baseline condition is established, the system prepares this information for display in the user interface. This involves creating visual representations of the data and the baseline condition, such as charts, graphs, or annotated timelines. These visuals help users easily understand the baseline's characteristics and how the data aligns or deviates from expected patterns. The system ensures that the user interface is intuitive and interactive, allowing users to explore the data and baseline condition in detail. It might include features such as tooltips, zooming, and filtering options to enhance user engagement and comprehension. The system may then render these visual elements on the user interface, ensuring that they are clearly labeled and easy to interpret. The system might use various visualization libraries and frameworks to achieve a high-quality, responsive display. By presenting the second baseline condition in a user-friendly format, the system enables users to make informed decisions based on the latest model's analysis, providing valuable insights into the behavior of the data stream.

In some embodiments, the system may compare the data points to the second baseline condition, detect an outlier based on comparing the data points to the second baseline condition, and generate an alert based on detecting the outlier. For example, when new (or previous) data points are collected, the system compares these points against the established baseline. Statistical methods, such as calculating z-scores or using interquartile ranges, help in identifying deviations from the norm. If a data point significantly deviates from the baseline, it is flagged as an outlier. The system employs predefined criteria to determine the extent of deviation necessary to qualify as an outlier, which could involve dynamic thresholds that adjust based on data trends. Upon detecting an outlier, the system generates an alert, which could be in the form of notifications, emails, or visual indicators on a dashboard. This alert notifies stakeholders of potential issues, prompting further investigation or immediate action to address the anomaly. The continuous monitoring and comparison process ensures timely identification of irregularities maintaining the system's robustness and reliability.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for adjusting sensitivity of changepoint detection using dynamic hyperparameters.
2. The method of any one of the preceding embodiments, further comprising: receiving a first data stream comprising data points corresponding to a first period of time; determining a first baseline condition for the first data stream using a first model, wherein the first model comprises a first number of changepoints; receiving a first dynamic hyperparameter, wherein the first dynamic hyperparameter comprises a first function that uses a first characteristic of the first model to generate a first output; determining, based on the first output, a second number of changepoints for modeling the first data stream in a second model; and generating for display, in a user interface, a second baseline condition for the first data stream using the second model.
3. The method of any one of the preceding embodiments, further comprising: comparing the data points to the second baseline condition; detecting an outlier based on comparing the data points to the second baseline condition; and generating an alert based on detecting the outlier.
4. The method of any one of the preceding embodiments, wherein receiving the first dynamic hyperparameter further comprises: receiving a first value from a user; determining, using the first function, a required characteristic based on the first value; comparing the required characteristic to the first characteristic; and generating the first output based on comparing the required characteristic to the first characteristic.
5. The method of any one of the preceding embodiments, wherein receiving the first dynamic hyperparameter further comprises: receiving a first value from a user; determining, using the first function, a type of a required characteristic based on the first value; and selecting the first characteristic from a plurality of characteristics based on the type.
6. The method of any one of the preceding embodiments, wherein the first function: determines a number of parameters within the first model; and determines the first characteristic based on the number of parameters.
7. The method of any one of the preceding embodiments, wherein the first function: determines a size of a layer within the first model; and determines the first characteristic based on the size of the layer.
8. The method of any one of the preceding embodiments, wherein the first function: determines a type of activation function used by the first model; and determines the first characteristic based on the type of activation function.
9. The method of any one of the preceding embodiments, wherein the first function: determines a size of a training data set used to train the first model; and determines the first characteristic based on the size of the training data set.
10. The method of any one of the preceding embodiments, wherein the first function: determines a penalty term for the first model; and determines the first characteristic based on the penalty term.
11. The method of any one of the preceding embodiments, wherein the first function: determines a polynomial degree of the first model; and determines the first characteristic based on the polynomial degree.
12. The method of any one of the preceding embodiments, wherein determining the first baseline condition for the first data stream using the first model comprises: dividing the first data stream into a series of segments, wherein the segments of the series of segments are separated by changepoints; determining respective baseline traffic levels for each of the segments; aggregating the respective baseline traffic levels to determine the first baseline condition.
13. The method of any one of the preceding embodiments, wherein the first function: determines an error rate of the first model; and determines the first characteristic based on the error rate.
14. The method of any one of the preceding embodiments, wherein the first function: determines an accuracy of the first model; and determines the first characteristic based on the accuracy.
15. The method of any one of the preceding embodiments, wherein the first function: determines a Mean Squared Error of the first model; and determines the first characteristic based on the Mean Squared Error.
16. The method of any one of the preceding embodiments, wherein the first function: determines a second output based of the first model using a test dataset; validating the first model based on the second output; and determines the first characteristic based on validating the first model.
17. One or more non-transitory, computer-readable mediums storing instructions that, when executed by a data processing apparatus, cause the data processing apparatus to perform operations comprising those of any of embodiments 1-16.
18. A system comprising one or more processors; and memory storing instructions that, when executed by the processors, cause the processors to effectuate operations comprising those of any of embodiments 1-16.
19. A system comprising means for performing any of embodiments 1-16.

What is claimed is:

1. A system for detecting network traffic disruptions based on varying network traffic baselines that are detected by adjusting a sensitivity of changepoint detection using dynamic hyperparameters, the system comprising:
one or more processors; and
one or more non-transitory, computer-readable mediums comprising instructions that when executed by the one or more processors causes operations comprising:
receiving a first data stream comprising data points corresponding to network traffic over a first period of time;
dividing the first data stream into a series of segments, wherein the segments of the series of segments are separated by changepoints;
determining respective baseline traffic levels for each of the segments;
aggregating the respective baseline traffic levels to determine a first baseline traffic level for the first data stream;
receiving a first dynamic hyperparameter, wherein the first dynamic hyperparameter comprises a first function that uses a first characteristic of the first baseline traffic level to generate a first output;
determining, based on the first output, a number of changepoints for modeling the first data stream;
determining a second baseline traffic level for the first data stream based on the number of changepoints; and
generating for display, in a user interface, an alert for a network traffic disruption based on detecting an outlier data point based on the second baseline traffic level.

2. A method for adjusting sensitivity of changepoint detection using dynamic hyperparameters, the method comprising:
receiving a first data stream comprising data points corresponding to a first period of time;
determining a first baseline condition for the first data stream using a first model, wherein the first model comprises a first number of changepoints;
receiving a first dynamic hyperparameter, wherein the first dynamic hyperparameter comprises a first function that uses a first characteristic of the first model to generate a first output;
determining, based on the first output, a second number of changepoints for modeling the first data stream in a second model; and
generating for display, in a user interface, a second baseline condition for the first data stream using the second model.

3. The method of claim 2, further comprising:
comparing the data points to the second baseline condition;
detecting an outlier based on comparing the data points to the second baseline condition; and
generating an alert based on detecting the outlier.

4. The method of claim 2, wherein receiving the first dynamic hyperparameter further comprises:
receiving a first value from a user;
determining, using the first function, a required characteristic based on the first value;
comparing the required characteristic to the first characteristic; and
generating the first output based on comparing the required characteristic to the first characteristic.

5. The method of claim 2, wherein receiving the first dynamic hyperparameter further comprises:
receiving a first value from a user;
determining, using the first function, a type of a required characteristic based on the first value; and
selecting the first characteristic from a plurality of characteristics based on the type.

6. The method of claim 2, wherein the first function:
determines a number of parameters within the first model; and
determines the first characteristic based on the number of parameters.

7. The method of claim 2, wherein the first function:
determines a size of a layer within the first model; and
determines the first characteristic based on the size of the layer.

8. The method of claim 2, wherein the first function:
determines a type of activation function used by the first model; and
determines the first characteristic based on the type of activation function.

9. The method of claim 2, wherein the first function:
determines a size of a training data set used to train the first model; and
determines the first characteristic based on the size of the training data set.

10. The method of claim 2, wherein the first function:
determines a penalty term for the first model; and
determines the first characteristic based on the penalty term.

11. The method of claim 2, wherein the first function:
determines a polynomial degree of the first model; and
determines the first characteristic based on the polynomial degree.

12. The method of claim 2, wherein determining the first baseline condition for the first data stream using the first model comprises:
dividing the first data stream into a series of segments, wherein the segments of the series of segments are separated by changepoints;
determining respective baseline traffic levels for each of the segments;
aggregating the respective baseline traffic levels to determine the first baseline condition.

13. The method of claim 2, wherein the first function:
determines an error rate of the first model; and
determines the first characteristic based on the error rate.

14. The method of claim 2, wherein the first function:
determines an accuracy of the first model; and
determines the first characteristic based on the accuracy.

15. The method of claim 2, wherein the first function:
determines a Mean Squared Error of the first model; and
determines the first characteristic based on the Mean Squared Error.

16. The method of claim 2, wherein the first function:
determines a second output based of the first model using a test dataset;
validating the first model based on the second output; and
determines the first characteristic based on validating the first model.

17. One or more non-transitory, computer-readable mediums, comprising instructions that, when executed by one or more processors, cause operations comprising:
determining a first baseline condition for a first data stream using a first model, wherein the first model comprises a first number of changepoints;
receiving a first dynamic hyperparameter, wherein the first dynamic hyperparameter comprises a first function that uses a first characteristic of the first model to generate a first output;
determining, based on the first output, a second number of changepoints for modeling the first data stream in a second model; and
generating for display, in a user interface, a second baseline condition for the first data stream using the second model.

18. The method of claim 2, further comprising:
comparing data points in the first data stream to the second baseline condition;
detecting an outlier based on comparing the data points to the second baseline condition; and
generating an alert based on detecting the outlier.

19. The method of claim 2, wherein receiving the first dynamic hyperparameter further comprises:
receiving a first value from a user;
determining, using the first function, a type of a required characteristic based on the first value; and
selecting the first characteristic from a plurality of characteristics based on the type.

20. The method of claim 2, wherein the first function:
determines a number of parameters within the first model; and
determines the first characteristic based on the number of parameters.
